(19) United States
(12) Patent Application Publication
(10) Pub. No.: US 2020/0366801 A1
(43) Pub. Date: Nov. 19, 2020

(54) IMAGE FORMING APPARATUS AND START KEY ARRANGEMENT METHOD

(71) Applicant: SHARP KABUSHIKI KAISHA, Sakai City (JP)

(72) Inventor: TAKUYA KOUJIRO, Sakai City (JP)

(21) Appl. No.: 16/870,442

(22) Filed: May 8, 2020

(30) Foreign Application Priority Data
May 16, 2019 (JP) 2019-092953

(51) Int. Cl. H04N 1/00

(52) U.S. Cl. CPC H04N 1/00474; H04N 2201/0094; H04N 1/00384

(57) ABSTRACT

An image forming apparatus includes an image former that selectively executes the same type of image formation in different modes, start key for each of the modes that receives a job start instruction for that mode of image formation, and an operation panel on which the start keys are arranged. One of the start keys and another of the start keys are arranged obliquely rather than vertically or horizontally when a user directly faces the operation panel.

### BACKGROUND OF THE INVENTION

### Field of the Invention

The present invention relates to an image forming apparatus including a plurality of start keys corresponding to jobs having different finishes and receiving an instruction to start execution of each of the jobs, and relates also to a method of arranging the start keys.

### Description of the Background Art

In recent years, digital multifunctional apparatuses in which one image forming apparatus executes different types of jobs such as fax, scanning, and copy, have been widely used. Not only medium and large-sized digital multifunctional apparatuses but also small-sized digital multifunctional apparatuses to be used in small offices and for personal use have been widespread.

Different types of jobs differ from each other in many setting items. The number of operation keys that receive setting and instructions tends to increase to receive settings and start instructions for the types of jobs.

Some of the medium or large-sized apparatuses have an ingenious configuration in which a dot matrix type display device and a touch panel are employed, and only a necessary operation key is displayed on the display device in accordance with the circumstances. However, actually, in the small-sized apparatuses having especially strict cost constraints, a large number of physical operation keys have to be arranged on an operation panel.

Further, even if the dot matrix type display device is employed, it may be necessary to arrange a large number of operation keys in a limited display area.

Even if jobs are of the same type, some of the jobs have different modes, that is, different image forming modes. A typical example of the different image forming modes is a monochrome job in which a read image is output in monochrome, and a color job in which a read image is output in color.

As described above, the different types of jobs differ from each other in many setting items. In comparison, jobs having different modes tend to have setting items common to each other. Thus, apparatuses are known in which, after setting is completed, start keys that receive a start instruction for a job are juxtaposed for each mode and the job is started in a mode in accordance with a start key that receives an operation (see, for example, Japanese Unexamined Patent Application Publication No. 2006-20032 and Japanese Unexamined Patent Application Publication No. 2011-242828).

### SUMMARY OF THE INVENTION

In an aspect in which start keys for each of modes are juxtaposed, a user can complete a setting, select a mode, and instruct a start of a job, in one operation, which is convenient; however, the user may operate a start key different from that for the intended mode by mistake. It can be said that the closer the start keys for the modes are arranged, the higher is the possibility of an erroneous operation. However, if the start keys for the modes are arranged apart from each other, the relevance between the modes (start keys) is difficult to be recognized and the operability is reduced.

The present invention has been made in view of the above circumstances, and provides a configuration in which, even if start keys for modes are arranged close to each other, it is easy for a user to recognize the relevance between the start keys and to distinguish between the start keys so that an erroneous operation hardly occurs.

The present invention provides an image forming apparatus including: an image former that selectively executes the same type of image formation in different modes; start key for each of the modes that receives a job start instruction for that mode of image formation; and an operation panel on which the start keys are arranged, in which one of the start keys and another of the start keys are arranged obliquely rather than vertically or horizontally when a user directly faces the operation panel.

Further, from a different point of view, the present invention provides a method of arranging start keys for modes, on an operation panel in an image forming apparatus that selectively executes the same type of image formation in different modes, the start key for each of the modes that receives a job start instruction for that mode of image formation. The method includes: arranging one of the start keys and another of the start keys obliquely rather than vertically or horizontally when a user directly faces the operation panel.

In the image forming apparatus according to the present invention, one of the start keys and another of the start keys are arranged obliquely rather than vertically or horizontally when a user directly faces the operation panel, and thus, even if the start keys are arranged close to each other, it is possible for the user to easily recognize the relationship between the start keys and to distinguish between the start keys so that an erroneous operation hardly occurs. The same applies to a method of arranging start keys according to the present invention.

### BRIEF DESCRIPTION OF THE DRAWINGS

FIG. 1 is a block diagram illustrating a configuration of an image forming apparatus according to the present embodiment;

FIG. 2 is a perspective view illustrating an external appearance of a digital multifunctional apparatus illustrated in FIG. 1;

FIG. 3 is an explanatory diagram illustrating an arrangement example of an operation panel device in the present embodiment (first embodiment);

FIG. 4 is an explanatory diagram illustrating an arrangement example of an operation panel device in the present embodiment (second embodiment);

FIG. 5 is an explanatory diagram illustrating an arrangement example of an operation panel device in the present embodiment (third embodiment);

FIG. 6 is an explanatory diagram illustrating a different arrangement example of an operation panel device in the present embodiment (fourth embodiment); and

FIG. 7 is an explanatory diagram illustrating an arrangement example of an operation panel device in the present embodiment (fifth embodiment).

### DESCRIPTION OF THE PREFERRED EMBODIMENTS

The present invention will be described below in more detail with reference to the drawings. It is noted that the following description is an exemplified illustration in all aspects and should not be interpreted to limit the present invention.

### First Embodiment

Configuration of Image Forming Apparatus

First, an image forming apparatus according to the present embodiment will be described.

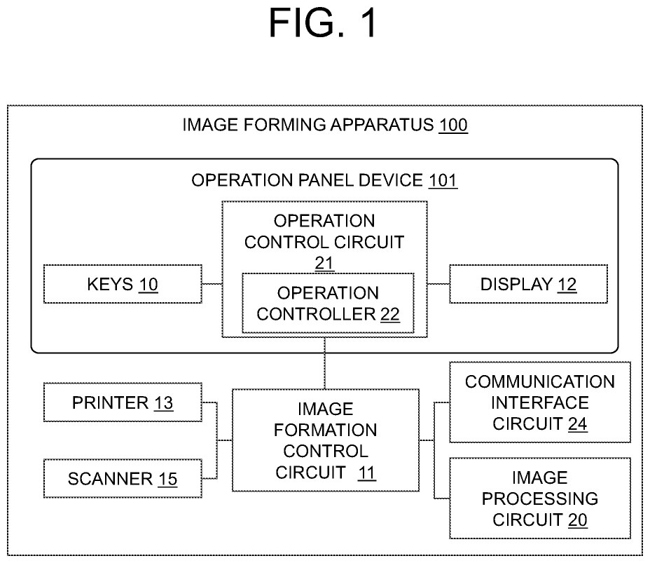

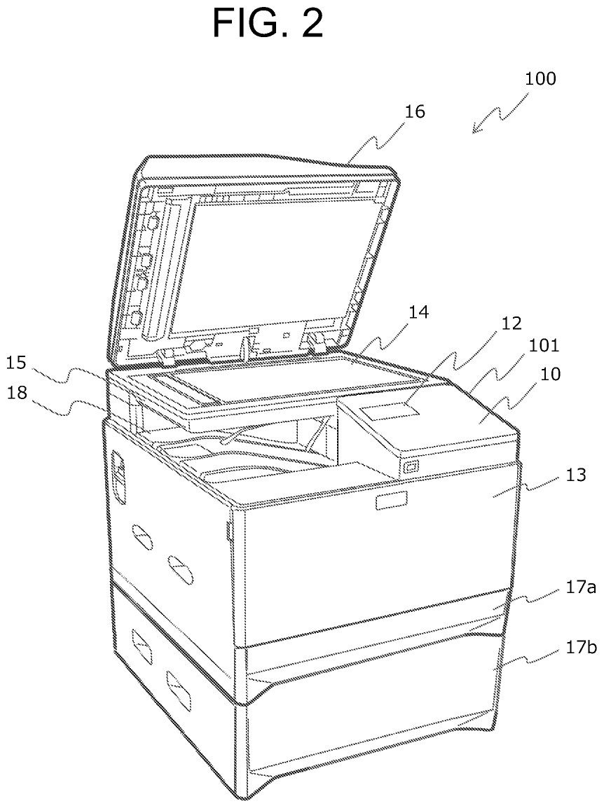

FIG. 1 is a block diagram illustrating a configuration of a digital multifunctional apparatus being one aspect of the image forming apparatus according to the present embodiment. FIG. 2 is a perspective view illustrating an external appearance of the digital multifunctional apparatus illustrated in FIG. 1.

As illustrated in FIG. 1, an image forming apparatus 100 includes an operation panel device 101, an image formation control circuit 11, a printer 13, a communication interface circuit 24, a scanner 15, and an image processing circuit 20. The operation panel device 101 includes keys 10, a display 12, and an operation control circuit 21.

The operation control circuit 21 includes, as hardware resources, a Central Processing Unit (CPU) or a Micro Processing Unit (MPU) (hereinafter, for simplicity, the CPU and the MPU are collectively referred to as a CPU in the present description), and a memory. If the CPU executes a control program stored in the memory, a function of an operation controller 22 is realized.

Further, control of the keys 10 and the display 12 is realized if the CPU executes not only screen control of the display 12, but also a control program related to an operation and a display in a wider sense. In other words, the function of the operation controller 22 is a part of an operation and display control function of the operation control circuit 21.

The operation controller 22 causes the display 12 to display a display related to a user interface according to the control program. Then, the operation controller 22 receives and processes a user operation input on the keys 10.

As illustrated in FIG. 2, the operation panel device 101 is provided on a housing of the image forming apparatus 100, and includes a plurality of operation buttons that receive an operation by a user, and the display 12.

The CPU of the operation control circuit 21 recognizes a signal indicating an input operation on the keys 10.

The display 12 includes a liquid crystal display device, for example. The display 12 displays various types of information based on an input received by the keys 10 and a state of the image forming apparatus 100. The operation control circuit 21 generates and displays a content to be displayed on the display 12. Further, the operation control circuit 21 updates the display.

The image formation control circuit 11 detects states of each of components of the image forming apparatus 100 and controls an operation of the components. Specifically, the image formation control circuit 11 mainly includes a CPU and is configured of hardware resources such as a memory, an input/output interface circuit, and a timer circuit. If the CPU executes an image processing program stored in the memory, a function for image formation of the image forming apparatus 100 is realized.

More specifically, the image formation control circuit 11 includes a RAM and a ROM serving as the memory mentioned above. At least a part of the ROM may be a rewritable nonvolatile memory. The CPU reads the control program stored in the ROM and appropriately develops the control program into the RAM. Then, the CPU executes a process in accordance with the control program developed into the RAM to control the hardware provided in the image forming apparatus 100. That is, the software resources and the hardware resources cooperate to realize a function for image formation such as a printing process.

In FIG. 1, the operation panel device 101 and the image formation control circuit 11 each have a hardware configuration provided with an individual CPU and a memory. However, the operation panel device 101 and the image formation control circuit 11 may use common hardware resources to implement functions of the operation panel device 101 and the image formation control circuit 11.

The image formation control circuit 11 and the printer 13, and the image formation control circuit 11 and the scanner 15 are connected to transfer data to each other.

As illustrated in FIG. 2, the image forming apparatus 100 includes a platen 14 and a document carrier 16.

The scanner 15 reads an image of a document carried by the document carrier 16 or a document placed on the platen 14 under the control of the image formation control circuit 11 and converts the read image into an image signal. That is, the scanner 15 executes an image reading process in a copy job, a fax job, or a scanner job.

The image processing circuit 20 generates image data based on the image signal output from the scanner 15.

As illustrated in FIG. 2, the image forming apparatus 100 includes sheet trays 17a and 17b, and a discharge tray 18.

The sheet trays 17a and 17b separately store sheets for each of various sizes.

A sheet feed mechanism (not illustrated in FIGS. 1 and 2) feeds a sheet from a specified sheet tray into the printing device and carries the sheet to the printer 13, under the control of the image formation control circuit 11.

The printer 13 prints specified image data on a sheet fed from any one of the sheet trays 17a and 17b under the control of the image formation control circuit 11.

A sheet discharge mechanism (not illustrated in FIGS. 1 and 2) discharges a sheet printed by the printer 13 to the discharge tray 18.

The communication interface circuit 24 is an interface for communicating data with an external device via a network.

Arrangement of Keys and Display

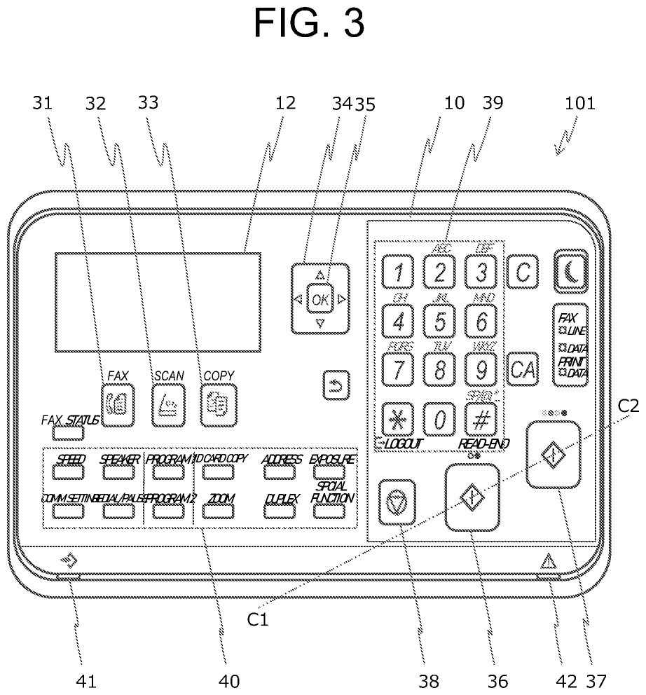

FIG. 3 is an explanatory diagram illustrating details of the operation panel device 101 of the image forming apparatus 100 illustrated in FIG. 2.

As illustrated in FIG. 3, a plurality of operation keys serving as the keys 10 are arranged in the operation panel device 101. The keys 10 includes a [fax] key 31, a [scanner] key 32, and a [copy] key 33 that receive a type of job to be executed by the image forming apparatus 100. These keys are self-illuminating, and the CPU of the operation control circuit 21 turns on a lamp of a key corresponding to a selected job. Further, the three keys are arranged horizontally next to each other. A FAX STATUS key near the [fax] key 31 receives an operation such as a stop of sending a fax or a canceling of a transmission reservation.

The display 12 is arranged at a far side relative to the three keys. The display 12 according to the present embodiment is a liquid crystal display device that displays an operation menu and a state of the image forming apparatus 100 with characters and icons over five lines. However, the display 12 is not limited thereto.

A plurality of setting keys 40 that correspond to various types of jobs such as fax, scanning, and copy, and receive settings for the various types of jobs are arranged in an area on a near side relative to the three keys. Operation keys of the setting keys 40 are orderly arranged in two horizontal rows and six vertical columns.

A direction key 34 and an [OK] key 35 are arranged on the right side of the display 12. The direction key 34 receives an operation for switching a selection item displayed on the display 12 in any of up, down, left, and right directions. The [OK] key 35 receives an operation for confirming a selected item.

A [return] key for returning to a previous display content on the display 12 is placed between the direction key 34 and the setting keys 40.

Numeric keys 39 are arranged on the right side of the direction key 34 and the setting keys 40. The numeric keys 39 receive an operation of inputting characters and numbers. Twelve keys including keys corresponding to the numbers zero to nine, an asterisk key, and a hash key are orderly arranged in a matrix of four horizontal rows and three vertical columns. The numeric keys 39 receive a setting such as the number of prints in a copy job and a telephone number of a transmission destination in a fax job.

A clear key marked “C” is placed on the horizontal right side of the “3” key located on the farthest and rightmost side among the numeric keys 39. The clear key receives an operation for deleting a set numerical value.

A clear all key marked “CA” is arranged on the horizontal right side of the “9” key being the third one from the farthest side of the numeric keys 39. The clear all key receives an operation of returning a current setting content and operation to the initial state.

Further, a [power saving] key with a crescent mark on the key top is arranged on the right of the clear key. The [power saving] key is self-illuminating, and receives an operation for switching to a power saving mode and an operation for canceling the power saving mode. The lamp lights up or blinks during the power saving mode.

A state of data communication in the fax and the printer and a progress state of a job are displayed on a near side relative to the [power saving] key.

Further, a data lamp 41 is placed on the left end at a near side of the operation panel device 101, and an error lamp 42 is placed on the right end at the near side of the operation panel device 101. The data lamp 41 lights up if a job such as sheet feeding and sheet discharging related to fax reception is being executed. The error lamp 42 lights up if toner is nearly empty, and blinks to notify the user of a state where the apparatus does not work without a user action, such as a sheet jam or exhaustion of toner.

A [monochrome start] key 36 and a [color start] key 37 are arranged on a near side at the right part of the keys 10. The [monochrome start] key 36 receives an operation for starting a monochrome copy or monochrome scanner job. The [color start] key 37 receives an operation for starting a color copy or color scanner job. The [monochrome start] key 36 and the [color start] key 37 have the same size.

The [monochrome start] key 36 and the [color start] key 37 are arranged next to each other obliquely rather than vertically or horizontally. The [monochrome start] key 36 and the [color start] key 37 are arranged along a direction indicated by a two-dot dashed line passing through C1 and C2 in FIG. 3.

The [monochrome start] key 36 and the [color start] key 37 are arranged beside the numeric keys 39 arranged in a vertical and horizontal matrix. However, the center of the [monochrome start] key 36 arranged on a near side relative to the numeric keys 39 is shifted with respect to all of the three columns in which the numeric keys 39 are arranged in the vertical direction, and is not aligned with any of the columns. Further, the center of the [color start] key 37 arranged on the right side of the numeric keys 39 is shifted with respect to all of the four rows in which the numeric keys 39 are arranged in the horizontal direction, and is not aligned with any of the rows.

Therefore, it is possible for the user to easily visually recognize the [monochrome start] key 36 and the [color start] key 37 arranged to be shifted from the orderly arrangement of the large number of operation keys on the operation panel device 101. Further, it is assumed that the [monochrome start] key 36 arranged at a near side in the vertical direction of the operation panel device 101, that is, closer to the user, is more easily recognized as an operation key for a main mode than the [color start] key 37 located farther from the user.

The operation panel device 101 is arranged at the right end of the image forming apparatus 100, as illustrated in FIG. 2. If the user stands and performs an operation at the horizontal center of the image forming apparatus 100, the [monochrome start] key 36 is closer to the user than the [color start] key 37 in the horizontal direction.

Further, when executing a job, the user operates any one of the [fax] key 31, the [scanner] key 32 and the [copy] key 33 arranged at the left part of the operation panel device 101 to select a type of job and uses the setting keys 40, the direction key 34, and the [OK] key 35 to perform setting of the job. The user uses the numeric keys 39 to set a fax destination number, a transmission destination mail address of the scanner, the number of copies to be printed, and the like, and operates the [monochrome start] key 36 or the [color start] key 37 to start execution of the job. That is, an operation flow basically proceeds from the left side to the right side of the operation panel device 101, and finally, the [monochrome start] key 36 or the [color start] key 37 is operated. In consideration of the operation flow, it is assumed that the [monochrome start] key 36 arranged upstream, that is, closer to the operation keys on the left side, is more easily recognized as the operation key for a main mode than the [color start] key 37 farther from the operation keys on the left side.

The monochrome job is described as being a main mode with respect to the color job, however, this is merely an example, and the color job may be a main mode. In this case, the arrangement of the [monochrome start] key 36 and the [color start] key 37 may be exchanged in FIG. 3.

In FIG. 3, a [stop] key 38 is placed to the left of the [monochrome start] key 36 for the main mode. The [stop] key 38 receives an operation for stopping execution of a job.

The [stop] key 38 is placed vertically beside the asterisk key located on the near side and at the leftmost part of the numeric keys 39, and is placed next to the asterisk key and at the near side relative the asterisk key.

The start keys are all physical operation keys in the present embodiment, but are not limited thereto. For example, the start keys may be operation keys (so-called soft keys) displayed on a display device, in which operations of the operation keys are detect on a touch panel or the like. The same applies to another operation key.

### Second Embodiment

In FIG. 3, the [stop] key 38 and the [monochrome start] key 36 are arranged next to each other obliquely rather than vertically or horizontally. However, this arrangement is not limiting, and the [stop] key 38 and the [monochrome start] key 36 may be arranged to be aligned horizontally, for example. If the [stop] key 38 and the [monochrome start] key 36 are arranged to be aligned horizontally, it is easy for the user to instruct an operation of stopping execution of a job with the [monochrome start] key 36 for a main mode.

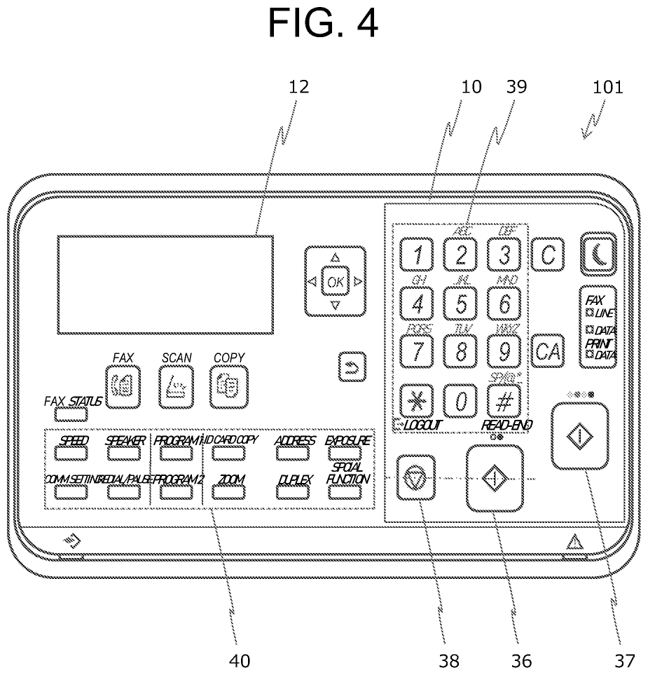

FIG. 4 is an explanatory diagram illustrating an arrangement example of the operation panel device in the present embodiment.

In FIG. 4, the [stop] key 38 and the [color start] key 37 are arranged next to each other obliquely rather than vertically or horizontally. Even if the [stop] key 38 and the [monochrome start] key 36 are arranged next to each other horizontally, the [stop] key 38 and the [color start] key 37 are arranged obliquely, and thus, the user can easily recognize that the [monochrome start] key 36 is an operation key for a main mode.

### Third Embodiment

In the first embodiment, the [monochrome start] key 36 and the [color start] key 37 have the same size. However, the [monochrome start] key 36 and the [color start] key 37 may have different sizes. If the [monochrome start] key 36 and the [color start] key 37 have different sizes, the user can easily recognize which of the [monochrome start] key 36 and the [color start] key 37 is the operation key for a main mode.

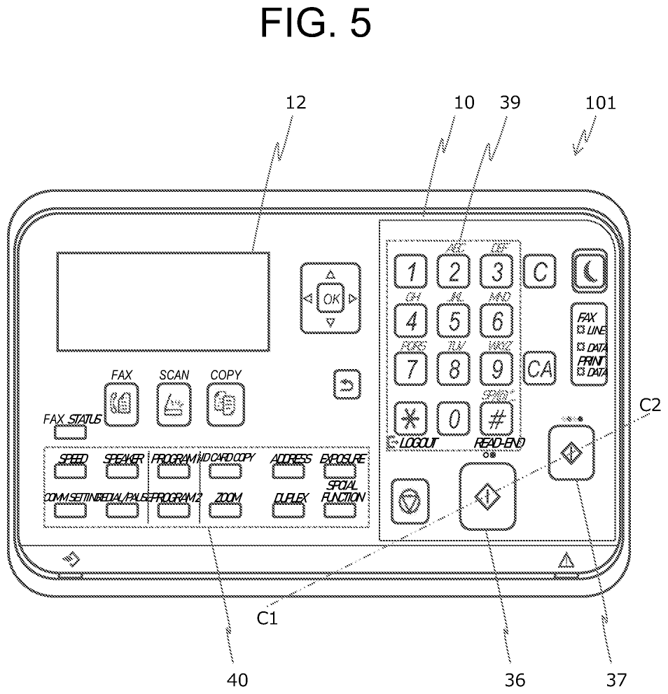

FIG. 5 is an explanatory diagram illustrating an arrangement example of the operation panel device in the present embodiment.

The difference from FIG. 3 is that the [color start] key 37 is slightly smaller than the [monochrome start] key 36.

According to the present aspect, it is assumed that the user can easily visually recognize that a monochrome job is a main mode, rather than a color job.

However, the [color start] key 37 is arranged obliquely with respect to the main [monochrome start] key 36, and thus, it is assumed that the presence of the [color start] key 37 is easily recognized even though the [color start] key 37 is smaller.

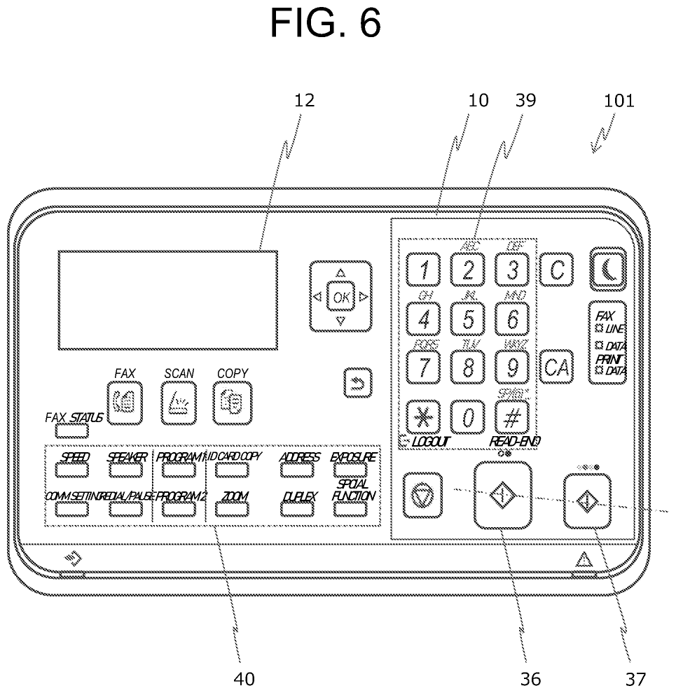

FIG. 6 is an explanatory diagram illustrating an arrangement example of the operation panel device according to the present embodiment that is different from FIG. 5. In FIG. 5, the line (indicated by C1-C2) passing through the centers of the [monochrome start] key 36 and the [color start] key 37 is inclined upward to the right while the line indicated by C1-C2 in FIG. 6 is inclined downward to the right.

### Fourth Embodiment

The above-described embodiments describe procedures allowing for easy visual recognition and distinguishing between the [monochrome start] key 36 and the [color start] key 37, however, the procedures are not limited thereto, and the [monochrome start] key 36 and the [color start] key 37 may be even more easily distinguished by using different operation forms between the [monochrome start] key 36 and the [color start] key 37.

For example, when the [monochrome start] key 36 is depressed, the operation controller 22 receives the depressing operation immediately (for example, 30 milliseconds after being depressed, assuming that there is some delay for noise removal or the like). On the other hand, when the [color start] key 37 is depressed, the operation controller 22 may receive the depressing operation if the [color start] key 37 is continuously depressed for a certain period (for example, for 300 milliseconds) after being depressed.

That is, the [monochrome start] key 36 receives an operation with a single touch, but the [color start] key 37 does not receive an operation unless being depressed for a long time.

This makes it easier for the user to sensuously distinguish between the [monochrome start] key 36 and the [color start] key 37, so that an erroneous operation is less likely to occur.

Alternatively, a configuration may be so that the [monochrome start] key 36 receives an operation even if being depressed with a small force, however, the [color start] key 37 does not receive an operation unless being depressed with a larger force.

That is, the [monochrome start] key 36 receives an operation with a light touch, but the [color start] key 37 does not receive an operation unless the user strongly touches the [color start] key 37.

This makes it easier for the user to sensuously distinguish between the [monochrome start] key 36 and the [color start] key 37, so that an erroneous operation is less likely to occur.

Further, alternatively, a configuration may be so that the [monochrome start] key 36 receives an operation even if being depressed with a short stroke, however, the [color start] key 37 does not receive an operation unless being depressed with a long stroke.

This makes it easier for the user to sensuously distinguish between the [monochrome start] key 36 and the [color start] key 37, so that an erroneous operation is less likely to occur.

The above-described differences in the operation forms may be combined.

### Fifth Embodiment

In the above-described embodiments, the [monochrome start] key 36 and the [color start] key 37 are operation keys completely separated from each other. However, even if outer shapes of the [monochrome start] key 36 and the [color start] key 37 are not completely separated, it is sufficient that the [monochrome start] key 36 and the [color start] key 37 are separated functionally.

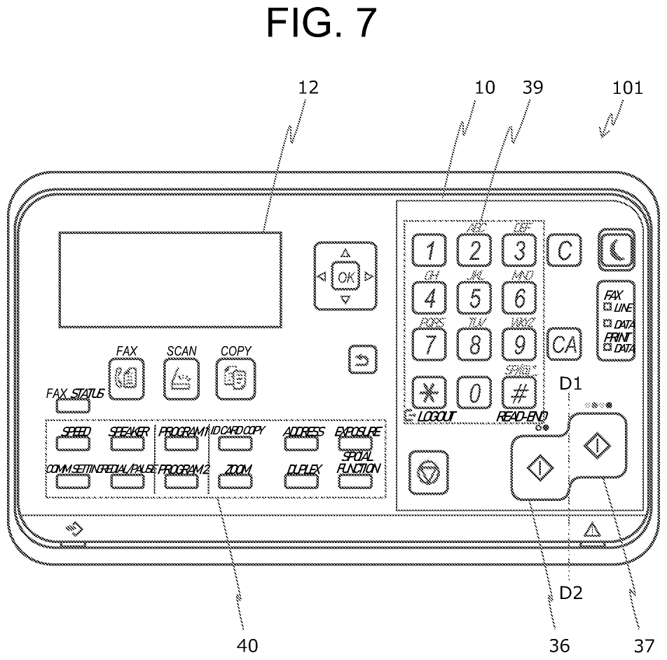

FIG. 7 is an explanatory diagram illustrating an arrangement example of the operation panel device according to the present embodiment. In FIG. 7, the [monochrome start] key 36 and the [color start] key 37 have key tops with a continuous outer shape and form a combined start key. However, the combined start key has a key top shape and marks so that the user can visually recognize that the start key is functionally separated to the left and right side with the two-dot dashed line D1-D2 as a boundary.

The combined start key has a seesaw-type structure in which if a key top on any one of the left side and the right side with respect to the boundary line D1-D2 is depressed, the key top on the depressed side sinks and the key top on the other side does not sink, and operation switches for detecting the depression of the key top are arranged on the left and right sides, respectively. The operation controller 22 determines that the key for the mode corresponding to the depressed side is operated.

According to the present embodiment, when a large number of operation keys are arranged in a limited area of the keys 10, the limited area can be effectively utilized if a combined start key is employed. For example, compared to the case where separate start keys are arranged as illustrated in FIG. 3, a larger key top can be arranged in an area having the same dimensions. Therefore, even if the operation keys are arranged close to each other, the [monochrome start] key 36 and the [color start] key 37 can be arranged so that the user can easily recognize and distinguish between the [monochrome start] key 36 and the [color start] key 37.

As described above,

(i) an image forming apparatus according to the present invention includes an image former that selectively executes the same type of image formation in different modes, start key for each of the modes that receives a job start instruction for that mode of image formation, and an operation panel on which the start keys are arranged, and one of the start keys and another of the start keys are arranged obliquely rather than vertically or horizontally when a user directly faces the operation panel.

In the present invention, the type of image formation refers to classes classified into fax, scanning, and copy, for example. However, the type is not limited thereto and may include document filing, for example.

The image formation mode refers to a mode such as a color mode or a monochrome mode, for example. However, the mode is not limited thereto and may include a mono-color mode, for example.

At least the start keys are arranged on the operation panel, and other operation keys (for example, numerical value setting keys) and a display device may be arranged. The numerical value setting keys correspond to the numeric keys in the embodiment described above.

If a user directly faces the operation panel, a state is obtained where the viewpoint of the user is placed at a position facing the front surface of the operation panel. A specific form thereof indicates, for example, a state where the viewpoint is in a direction in which the operation panel can be seen, as illustrated in FIG. 3.

Further, the arrangement and alignment of the start keys are based on the position of the center of gravity of each of the start keys, that is, the center of each of the start keys, in a case where the keys extending vertically and horizontally have a plate shape having a uniform thickness and uniform density at any point. The same applies to another operation key.

Further, if one of the start keys and another of the start keys are arranged obliquely rather than vertically or horizontally, the one of the start keys and the other of the start keys are arranged along a direction being neither perpendicular nor parallel to a reference direction being any one of the vertical direction or the horizontal direction of the operation panel.

If an object is arranged obliquely rather than vertically or horizontally among objects orderly arranged with the vertical direction and the horizontal direction as reference, human vision tends to easily recognize the object arranged obliquely, and thus, an erroneous operation is less likely to occur.

It is noted that, among the plurality of start keys, it is sufficient that at least one of the start keys and another of the start keys are arranged obliquely rather than vertically or horizontally. That is, for example, if three start keys are provided, it is sufficient that one of the start keys is arranged obliquely to another start keys, and the other two start keys may be arranged vertically and horizontally.

The start keys are all physical operation keys in the present embodiment, but are not limited thereto. For example, the start keys may be operation keys (so-called soft keys) displayed on a display device, in which operations of the operation keys are detect on a touch panel or the like.

Further, preferable aspects of the present invention will be described.

(ii) The one of the start keys and the other of the start keys may have different sizes.

Thus, the one of the start keys and the other of the start keys further differ in size, and thus, even if the two start keys are arranged close to each other, the user can easily distinguish between the start keys, so that an erroneous operation is less likely to occur.

(iii) The one of the start keys and the other of the start keys may have different manners of operation required for receiving an instruction.

Thus, even if the two start keys are arranged close to each other, the user can easily distinguish between the start keys, so that an erroneous operation is less likely to occur.

(iv) The manner of operation may be length of a period from when an operation of each of the start keys starts, to reception of an instruction.

Thus, the operation periods until the reception of the instruction are different from each other, and thus, even if the two start keys are arranged close to each other, an erroneous operation by the user is less likely to occur.

(v) The manner of operation may be magnitude of a force required to operate each of the start keys.

Thus, the magnitudes of the force required for the operation are different from each other, and thus, even if the two start keys are arranged close to each other, an erroneous operation by the user is less likely to occur.

(vi) The manner of operation may be magnitude of a stroke to receive an instruction when each of the start keys is depressed.

Thus, the magnitudes of the stroke until the operation is received are different from each other, and thus, even if the two start keys are arranged close to each other, an erroneous operation by the user is less likely to occur.

(vii) A stop key that receives an instruction to stop a job during execution, and a plurality of numerical value setting keys arranged either vertically or horizontally, or in a vertical and horizontal matrix, the plurality of numerical value setting keys that receive a numerical value setting for jobs, may be further provided, and the one of the start keys and the stop key may be arranged next to each other either vertically or horizontally, and the other of the start keys and the stop key may be arranged obliquely rather than vertically or horizontally.

Thus, there is a close relationship between the start key that receives a start instruction for a job and the stop key that receives a stop instruction for a job during execution, and thus, it is easy to visually recognize a relationship between the stop key and the start key arranged next to the stop key either vertically or horizontally, and to distinguish the start key from the other of the start keys arranged obliquely rather than vertically or horizontally to the stop key, so that an erroneous operation by the user is less likely to occur.

The plurality of numerical value setting keys are typically numeric keys as described in the above-described embodiment, but are not limited thereto. For example, the numerical value setting keys may include keys for instructing each of an addition and a subtraction of numerical values.

A direction in which the numerical value setting keys are aligned refers to a direction in which the numerical value setting keys are aligned in a state where a user directly faces the operation panel. If the numerical value setting keys are arranged in a line, the direction is used as a reference in the vertical direction or in the horizontal direction. If the numerical value setting keys are arranged in a matrix, the row and column directions of the matrix are used as a reference in the vertical direction and in the horizontal direction. It is assumed that the vertical and horizontal directions in which the numerical value setting keys are arranged coincide with the vertical and horizontal directions of the operation panel.

(viii) Jobs for image formation in the different modes may be a job for outputting a read image in monochrome and a job for outputting a read image in color.

Thus, even if a start key for the monochrome job and a start key for the color job are arranged close to each other, the user can easily distinguish between these start keys, and an erroneous operation is less likely to occur.

Preferred aspects of the present invention include combinations of any aspects among the above-described plurality of aspects.

In addition to the above-described embodiments, various modifications in the present invention are possible. These modifications should not be interpreted as not belonging to the scope of the present invention. The present invention should include a meaning equivalent to the claims and all modifications within the scope.

### DESCRIPTION OF REFERENCE NUMERALS

10: Keys, 11: Image formation control circuit, 12: Display, 13: Printer, 14: Platen, 15: Scanner, 16: Document carrier, 17a, 17b: Sheet tray, 18: Discharge tray, 20: Image processing circuit, 21: Operation control circuit, 22: Operation controller, 24: Communication interface circuit, 31: [Fax] key, 32: [Scanner] key, 33: [Copy] key, 34: Direction key, 35: [OK] key, 36: [Monochrome start] key, 37: [Color start] key, 38: [Stop] key, 39: Numeric keys, 40: Setting key, 41: Data lamp, 42: Error lamp, 100: Image forming apparatus, 101: Operation panel device

What is claimed is:

1. An image forming apparatus, comprising:
an image former that selectively executes the same type of image formation in different modes;
a start key for each of the modes that receives a job start instruction for that mode of image formation; and
an operation panel on which the start keys are arranged, wherein
one of the start keys and another of the start keys are arranged obliquely rather than vertically or horizontally when a user directly faces the operation panel.

2. The image forming apparatus according to claim 1, wherein one of the start keys and the other of the start keys have different sizes.

3. The image forming apparatus according to claim 1, wherein one of the start keys and the other of the start key require different manners of operation to receive an instruction.

4. The image forming apparatus according to claim 3, wherein the manner of operation to receive an instruction is length of a period from when an operation of the start keys starts, to reception of an instruction

5. The image forming apparatus according to claim 3, wherein the manner of operation to receive an operation is magnitude of a force required to operate each of the start keys.

6. The image forming apparatus according to claim 3, wherein the manner of operation is magnitude of a stroke to receive an instruction when each of the start keys is depressed.

7. The image forming apparatus according to claim 1, further comprising: a stop key that receives an instruction to stop a job during execution; and a plurality of numerical value setting keys arranged either vertically or horizontally, or in a vertical and horizontal matrix, the plurality of numerical value setting keys that receive a numerical value setting for jobs, wherein
the stop key is arranged next to one of the plurality of numerical value setting keys either vertically or horizontally, and the one of the start keys is arranged obliquely rather than vertically or horizontally to any one of the plurality of numerical value setting keys.

8. The image forming apparatus according to claim 1, wherein jobs for image formation in the different modes are a job for outputting a read image in monochrome and a job for outputting a read image in color.

9. A method of arranging start keys for different modes on an operation panel in an image forming apparatus that selectively executes the same type of image formation in the different modes, the start key for each of the modes that receives a job start instruction for that mode of image formation, comprising:
arranging one of the start keys and another of the start keys obliquely rather than vertically or horizontally when a user directly faces the operation panel.
